(19) United States
(12) Patent Application Publication
(10) Pub. No.: US 2006/0162399 A1
(43) Pub. Date: Jul. 27, 2006

(54) SECURITY LOCK WITH DUAL LOCKING MEANS

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/126,199

(22) Filed: May 11, 2005

(30) Foreign Application Priority Data
Jan. 27, 2005 (TW) 094201564

(51) Int. Cl. E05B 37/02

(52) U.S. Cl. 70/21; 70/284; 70/285

(57) ABSTRACT

A security lock that can be unlocked by the owner of the security lock by dialing an unlocking number or by authorized security personals with a general key. The security lock mainly contains: a lock body, a plugging device, a controlling device, a securing mechanism, a restriction device, a first locking means and a second locking means. The lock body has a first channel and a second channel therein. The plugging device is pluggable into the first channel. The controlling device is slidably secured within the second channel. The securing mechanism is for securing or releasing the plugging device. The restriction device is slidably deposed within the second channel against the controlling device for controlling movement thereof. The first locking means is formed in the lock body for being engaged with or disengaged from the restriction device. The second locking means is formed in the lock body for rotating the restriction device to be disengaged from the first locking means.

### TECHNICAL FIELD

This invention relates generally to a security lock, in particular, to provide a security lock with dual locking means.

### BACKGROUND OF THE INVENTION

Preventing personal stuffs from being lost or stolen, travelers usually lock their own travel baggage boxes. Combination lock is the most common lock that installed in a travel baggage box because it takes little space. Each traveler sets up his own security number for the combination lock. Thereby others without knowing the security number cannot unlock his baggage box. However terrorists may use travel baggage boxes to deliver explosive devices to endanger people's safety. Security personals in airports may need to exam travels' travel baggage boxes in some circumstances without presence of the owners of the travel baggage boxes. Some countries require travelers not to lock their travel baggage boxes. The travelers may lose their properties in their travel baggage boxes if they leave their travel baggage boxes unlocked. If they choose to lock their baggage boxes, the security personals are authorized to damage the travel baggage boxes in order to exam objects inside of the travel baggage boxes. There is a dilemma between travelers' rights and flight safety. Therefore, a security lock that can protect travels' properties and allow security personals to unlock the security lock is needed as well.

### SUMMARY OF INVENTION

It is therefore an objective of the present invention to provide a security lock that can be unlocked by the owner of the security lock by dialing an unlocking number or by authorized security personals with a general key.

The present invention, briefly summarized, in one embodiment discloses a security lock with dual locking means. The security lock mainly comprises: a lock body, a plugging device, a controlling device, a securing mechanism, a restriction device, a first locking means and a second locking means. The lock body has a first channel and a second channel therein. The plugging device is pluggable into the first channel. The controlling device is slidably secured within the second channel. The securing mechanism is for securing or releasing the plugging device. The restriction device is slidably deposed within the second channel against the controlling device for controlling movement thereof. The first locking means is formed in the lock body for being engaged with or disengaged from the restriction device. The second locking means is formed in the lock body for rotating the restriction device to be disengaged from the first locking means. Wherein when the restriction device is disengaged from the first locking means, the controlling device can be moved to drive the securing mechanism to release the plugging device and when the restriction device is secured by the first locking means, the second locking means can be driven by a key to have the restriction device rotated to be disengaged from the first locking means.

### BRIEF DESCRIPTION OF DRAWINGS

The invention will be more clearly understood after referring to the following detailed description read in conjunction with the drawings wherein:

FIG. 1 is a cross sectional view of the first embodiment of present invention wherein the plugging device is secured by the securing mechanism;

FIG. 2 is a perspective view of the first embodiment that the moving element is engaged with the gap of the restriction device and prevent the movement thereof;

FIG. 3 is a cross sectional view of the first embodiment of present invention wherein the plugging device is released from the securing mechanism;

FIG. 4 is a cross sectional view of the first embodiment of present invention wherein the key operated locking means is operated by a key and the restriction device is rotated to a position that the moving element is within the wide section of the gap;

FIG. 5 is a detailed view in part of the first embodiment wherein the moving element is within the wide section of the gap before the restriction device is moved downwardly;

FIG. 6 is a perspective view of the first embodiment wherein the moving element is within the wide section of the gap and the restriction device is moved downward to drive the securing mechanism;

FIG. 7 is a detailed view in part of the first embodiment wherein the moving element is within the wide section of the gap after the restriction device is moved downwardly

FIG. 8 is a perspective view of the second embodiment that installed in a luggage case;

FIG. 9 is a cross sectional view of the second embodiment wherein the controlling device is not movable when the plural number wheels are not dialed to unlocking numbers;

FIG. 10 is another cross sectional view of the second embodiment wherein the controlling device is not movable when the plural number wheels are not dialed to unlocking numbers;

FIG. 11 is a cross sectional view of the second embodiment wherein the controlling device is movable when the plural number wheels are dialed to unlocking numbers;

FIG. 12 is another cross sectional view of the second embodiment wherein the controlling device is movable when the plural number wheels are dialed to unlocking numbers and the moving element is disengaged from the restriction device;

FIG. 13 is a cross sectional view of the second embodiment wherein the restriction device is rotated by a key to a position that the restriction device is departed from against the controlling device whereby the controlling device can drive the securing mechanism to secure or release the plugging device; and

FIG. 14 is another cross sectional view of the second embodiment wherein the restriction device is rotated by a key to a position that the restriction device is departed from against the controlling device and the controlling device has driven the securing mechanism to release the plugging device.

### DETAILED DESCRIPTION OF PREFERRED EMBODIMENTS

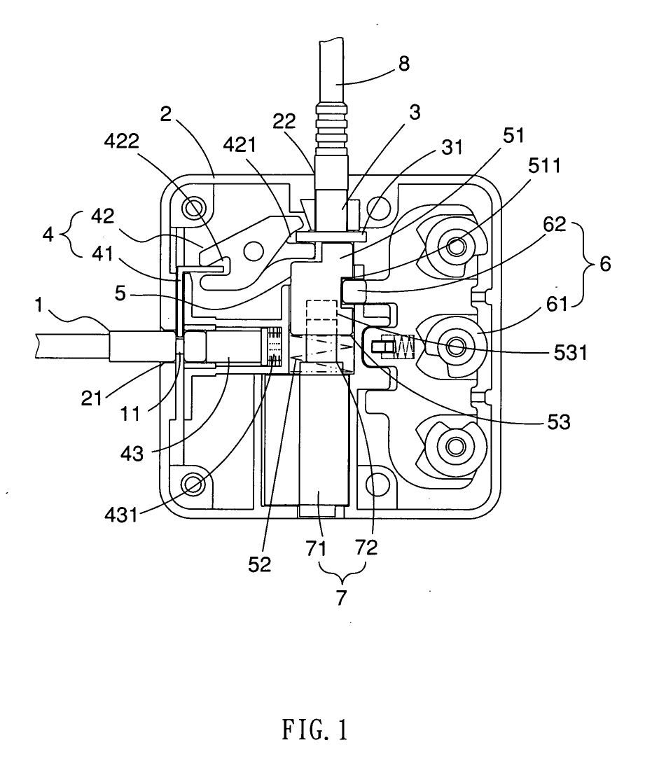

Please refer to FIG. 1 which shows a first embodiment of the present invention. The security lock mainly comprises: a lock body 2, a plugging device 1, a controlling device 3, a securing mechanism 4, a restriction device 5, a first locking means 6, a second locking means 7 and a cable 8 connected to the plugging device 1 with one end and connected to the controlling device 3 with the other end. The lock body 2 has a first channel 21 and a second channel 22 therein. The plugging device 1 is pluggable into the first channel 21. The controlling device 3 is slidably secured within the second channel 22. The securing mechanism 4 is for securing or releasing the plugging device 1. The restriction device 5 is slidably deposed within the second channel 22 against the controlling device 3 for controlling movement thereof. The first locking means 6 is formed in the lock body 2 for being engaged with or disengaged from the restriction device 5. The second locking means 7 is formed in the lock body 2 for rotating the restriction device 5 to be disengaged from the first locking means 6 whereby when the restriction device 5 is disengaged from the first locking mechanism 6, the controlling device 3 can be moved to drive the securing mechanism 4 to release the plugging device 1 and when the restriction device 5 is secured by the first locking means 6, the second locking means 7 can be driven by a key to have the restriction device 5 rotated to be disengaged from the first locking means 6.

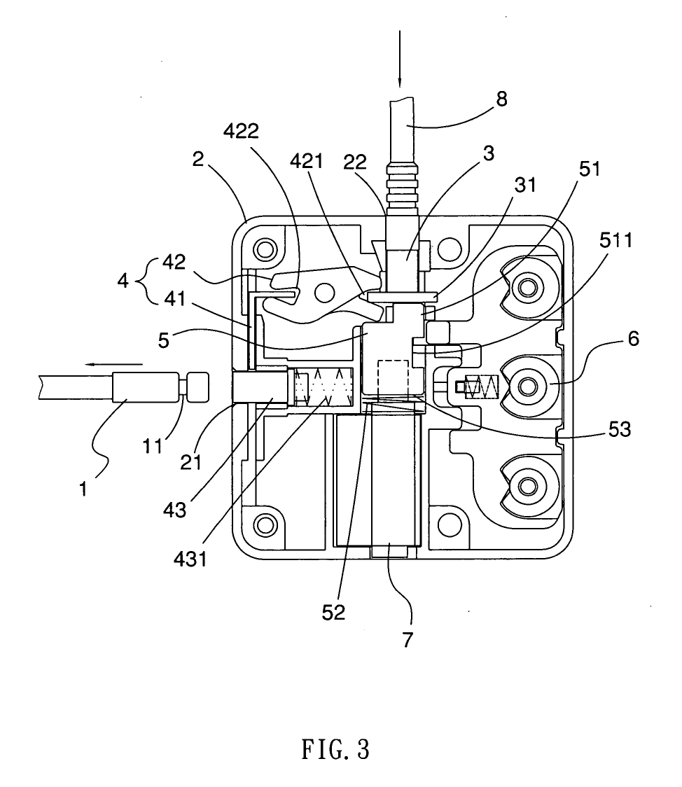

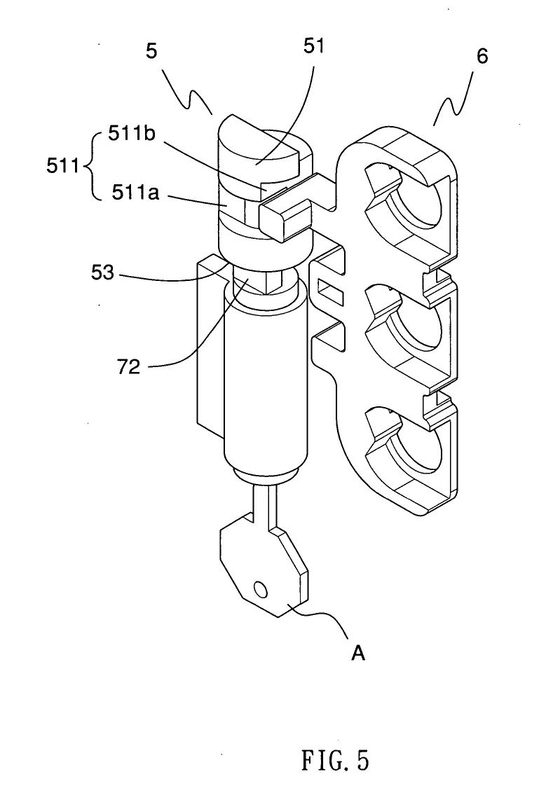

With reference to FIG. 1, FIG. 3, and FIG. 5, the restriction device 5 has a cylinder surface 51, and a bottom surface 53 having a cave 531 therein. The cylinder surface 51 has a gap 511 therein. The gap 511 has a narrow section 511a and wide section 511b. The first locking means 6 comprises a combination locking means with plural number wheels 61 and a moving element 62. The moving element 62 is movable when the plural number wheels 61 are dialed to unlocking numbers. The second locking means 7 is a key operated locking means having a body 71 and a rotor 72 extended therefrom and engaged with the cave 531 of the bottom surface 53 for rotating the restriction device 5 to be engaged with or disengaged from the moving element 62 of the first locking means 6 wherein when the moving element 62 is within the narrow section 511a of the gap 511, the restriction device 5 is engaged with the moving element 62 and the moving element 62 is held within the narrow section 511a of the gap 511. The wide section 511b of the gap 511 provides sufficient space for the restriction device 5 to move vertically while the moving element 62 is within the gap 51. When the moving element 62 is within the wide section 511b of the gap, the restriction device 5 is disengaged from the moving element 62 and the moving element 62 is movable vertically.

With reference to FIG. 1, and FIG. 3, a compression spring 52 is deposed on top of the body 71 of the key operated locking means 7, surrounding the rotor 72 and against the bottom surface 53 of the restriction device 5 whereby the compression spring 52 can restore the restriction device 5 to its original position after the restriction device 5 is moved downward by the controlling device 3 to drive the securing mechanism 4 to release the plugging device 1.

With reference to FIG. 1 and FIG. 3, the securing mechanism 4 has a securing element 41 for securing or releasing the plugging device 1 and a driving element 42 engaged with the restriction element 41 for driving the same. The plugging device 1 has a neck portion 11 for being engaged with the securing element 41. The controlling device 3 has a flange 31 at the end thereof engaged with a second aperture 421 at the second end of the driving element 42. The driving element 42 has a first aperture 422 at the first end engaged with the securing element 41. An ejecting mechanism 43 comprising a compression spring 431 is installed in the first channel 21 for ejecting the plugging device 1 when the securing element 41 is disengaged from the neck portion 11 of the plugging device 1.

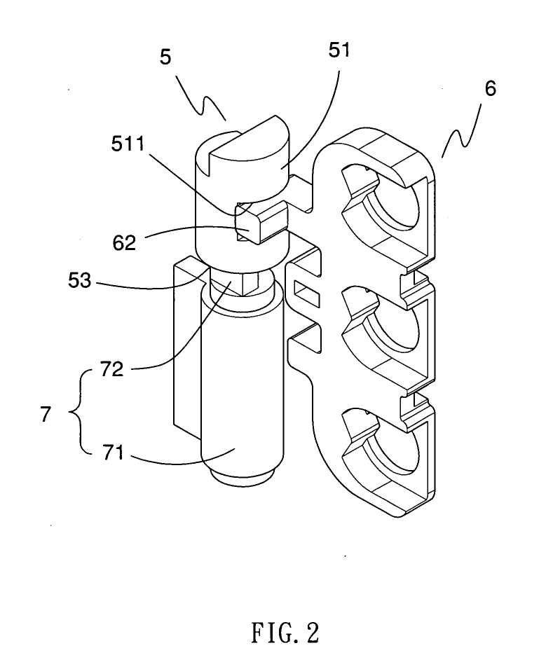

With reference to FIG. 1 and FIG. 2, before the plural number wheels 61 are dialed to the unlocking number, the moving element 62 of the first locking means 6 remains in the narrow section 511a of the gap 511 of the restriction device 5 and is not movable. Referring to FIG. 3, after plural number wheels 61 are dialed to the unlocking number, the moving element 62 is removed from the gap 511 and the controlling device 3 is moved downward to drive the driving element 42 turn clockwise and push the restriction device 5 move downward to compress the compression spring 52. Turning clockwise, the driving element 42 lifts the restricting element 41 and release the plugging device 1 from the first channel 21 and the ejecting mechanism 43 ejects the plugging device 1 out of the first channel 21.

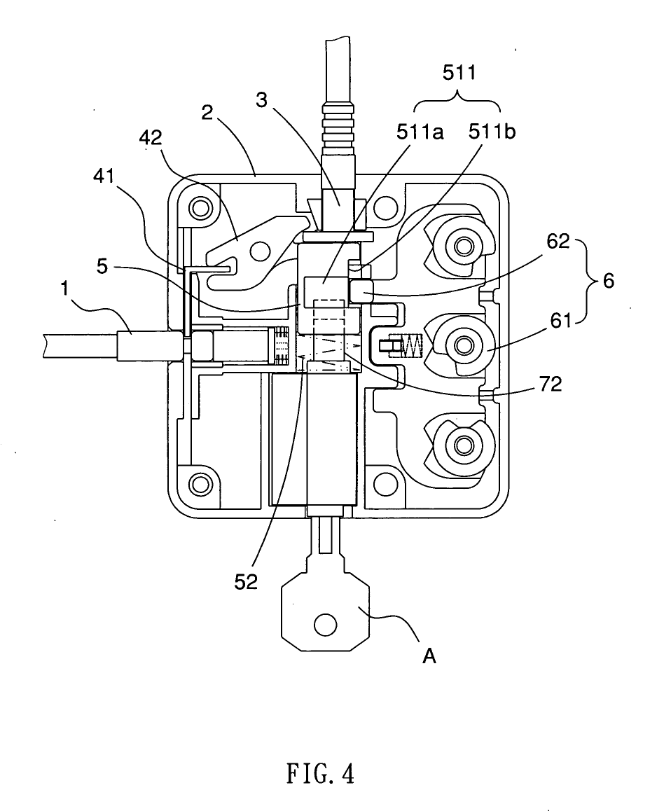

With reference to FIG. 4 and FIG. 5, the plural number wheels 61 are not dialed to the unlocking number, the moving element 62 of the first locking means 6 is not movable. A key A is inserted to the key operated locking means 7 and the key A turns the rotor 72 together with the restriction device 5 from a position that the moving element 62 is within the narrow section 511a of the gap 511 to the wide section 511b of the gap 511, whereby the restriction device 5 is movable vertically since the moving element 62 can no longer restrain the movement of the restriction device 5.

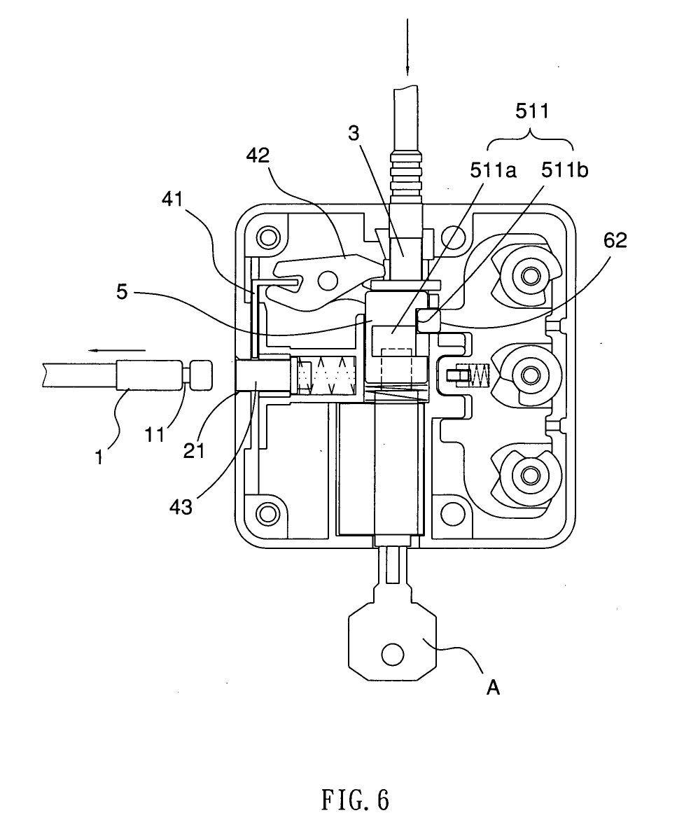

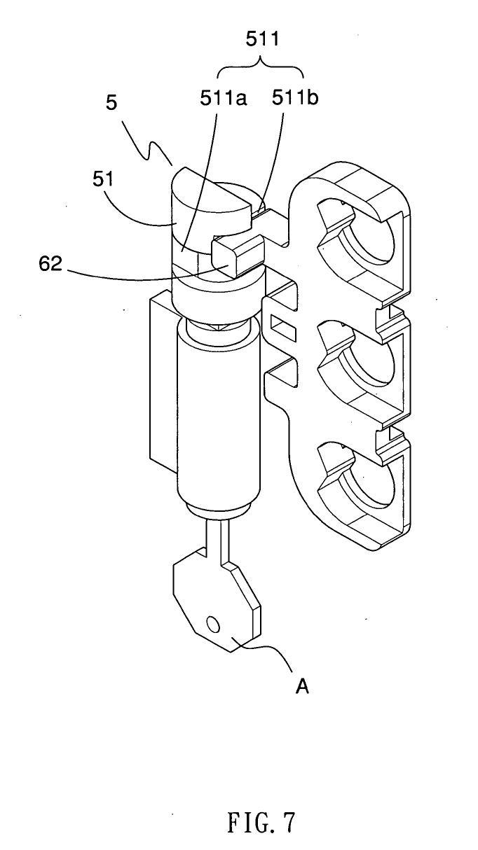

With reference to FIG. 6, after the key A turns the rotor 72 together with the restriction device 5 to a position that the moving element 62 in within the wide section 511b of the gap 511, the controlling device 3 is moved downward to drive the driving element 42 turn clockwise and push the restriction device 5 move downward to compress the compression spring 52. Turning clockwise, the driving element 42 lifts the restricting element 41 and release the plugging device 1 from the first channel 21 and the ejecting mechanism 43 ejects the plugging device 1 out of the first channel 21.

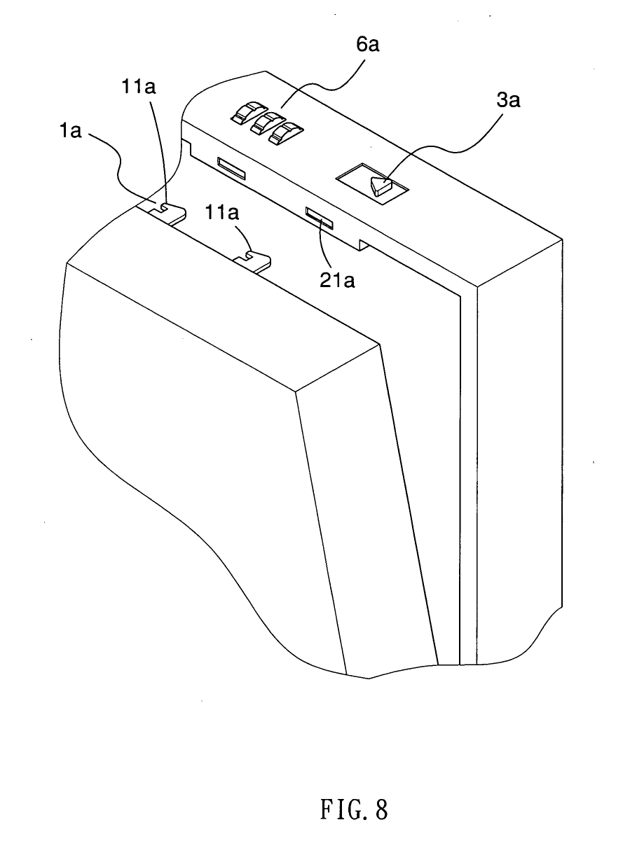

FIG. 8 to FIG. 10, illustrate the second embodiment of the present invention that installed in a luggage case. The second embodiment comprises a lock body 2a installed in the luggage case body, a plugging device 1a installed at the edge of the cover of the luggage case, a controlling device 3a, a securing mechanism 4a, a restriction device 5a, a first locking means 6a, a second locking means 7a. The restriction device 5a has a top surface 53a having a cave 531a therein. The first locking means 6a comprising a combination locking means having a moving element 62a and plural number wheels 61a for controlling the moving element 62a to be engaged with or disengaged from the restriction device 5a. The moving element 62a is disengaged from the restriction device 5a when the plural number wheels 61a are dialed to unlocking numbers. The second locking means 7a is a key operated locking means having a body 71a and a rotor 72a extended therefrom. The body 71a of the key operated locking means 7a is fixed in the lock body 2a. The rotor 72a is engaged with the cave 531a of the top surface 53a for rotating the restriction device 5a to be departed from against the controlling device 3a whereby the controlling device 3a can drive the securing mechanism 4a to secure or release the plugging device 1a.

The lock body 2a has a first channel 21a and a second channel 22a therein. The plugging device 1a is pluggable into the first channel 21a. The controlling device 3a is slidably secured within the second channel 22a. The securing mechanism 4a is for securing or releasing the plugging device 1a. The restriction device 5a is slidably deposed within the second channel 22a against the controlling device 3a for controlling movement thereof.

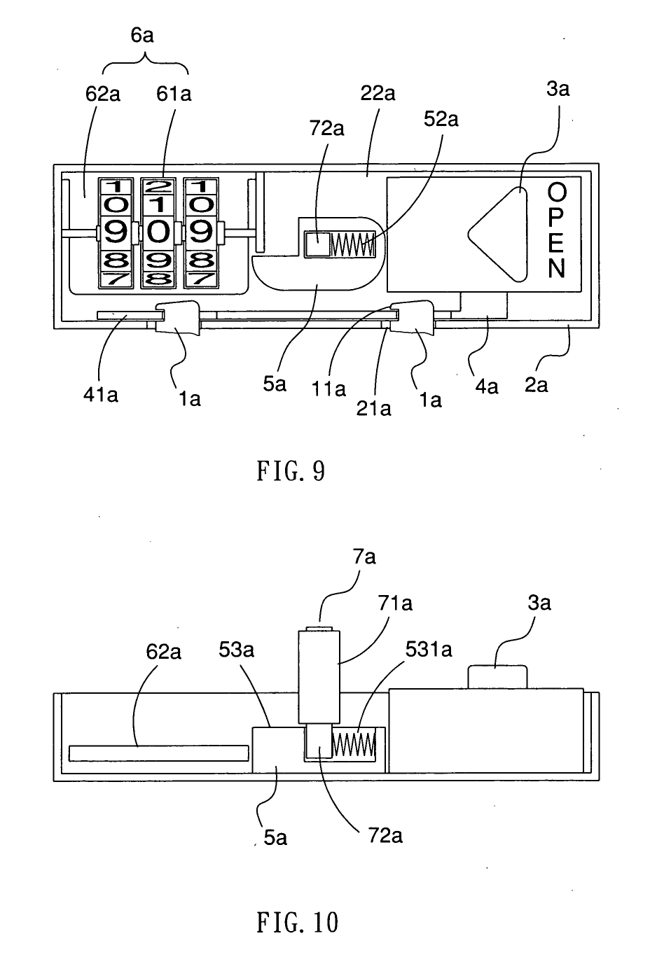

With reference to FIG. 9 to FIG. 12, a compression spring 52a is deposed within the cave 531a of the top surface 53a and is against an inner wall thereof with one end and against the rotor 72a of the key operated locking means 7a with the other end whereby the compression spring 52a can restore the restriction device 5a to its original position after being compressed. The securing mechanism 4a has a securing element 41a connected to the controlling device 3a for securing or releasing the plugging device 1a. The plugging device 1a has a hook portion 11a for being engaged with the securing element 41a.

Referring to FIG. 9 and FIG. 10, before the plural number wheels 61a are dialed to the unlocking number, the moving element 62a of the first locking means 6a is placed against the restriction device 5a and the restriction device 5a is placed against both the moving element 62a and the controlling device 3a at its both sides respectively. Hence the controlling device 3a is not movable and the securing mechanism 4a remains engaged with the plugging devices 1a.

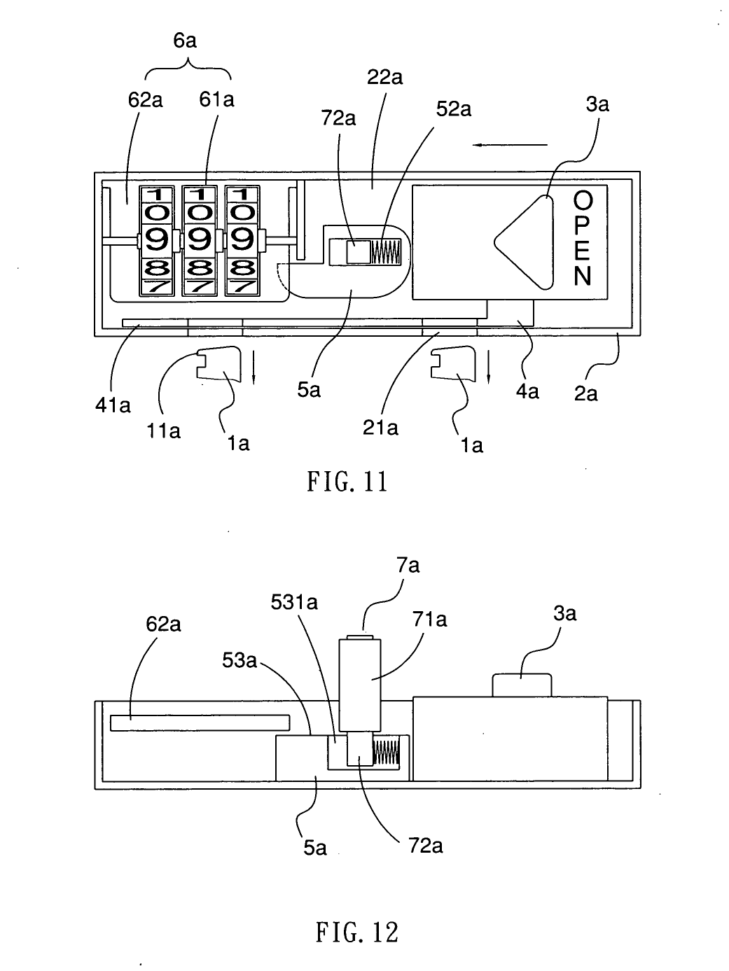

With reference to FIG. 11 and FIG. 12, after the plural number wheels 61a are dialed to the unlocking number, the moving element 62a of the first locking means 6a is disengaged from restriction device 5a. Accordingly, the controlling device 3a together with the restriction device 5a are moved leftward along the second channel 22a and the securing mechanism 4a connected to the controlling device 3a releases the plugging devices 1a.

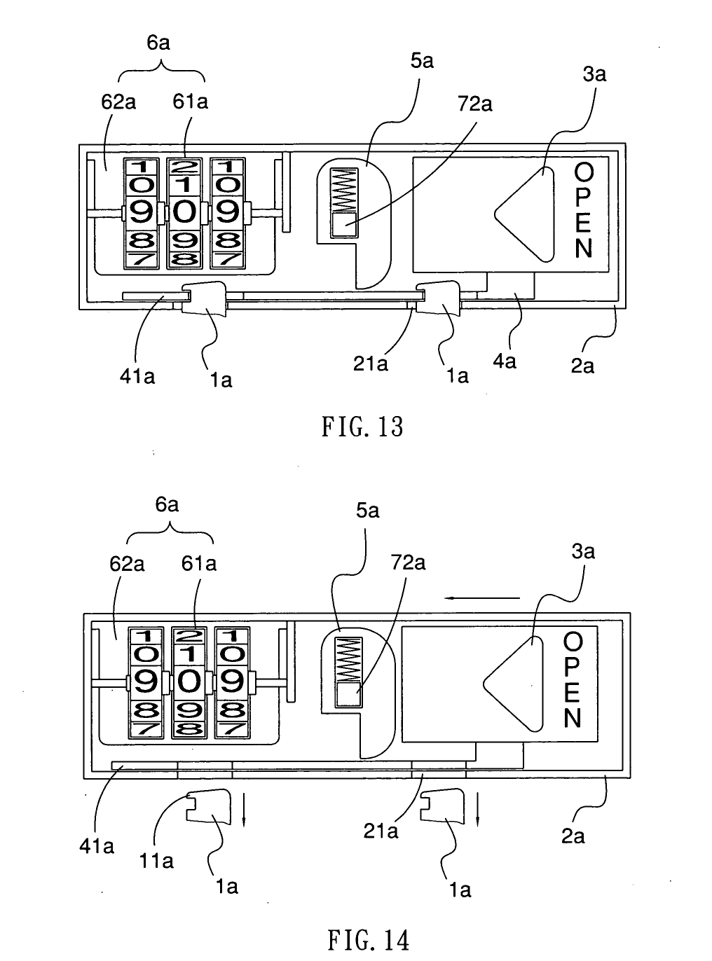

With reference to FIG. 13 and FIG. 14, the plural number wheels 61a are not dialed to the unlocking numbers, the moving element 62a of the first locking means 6a remains still. A key (not shown) is inserted to the key operated locking means 7a and the key turns the rotor 72a together with the restriction device 5a to a vertical position that the restriction device 5a is neither against the moving element 62a nor against the controlling device 3a. Referring to FIG. 14, after the restriction device 5a is turned to a vertical position, the controlling device 3a is moved leftward along the second channel 22a and the securing mechanism 4a connected to the controlling device 3a releases the plugging devices 1a.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

We claim:

1. A security lock comprising:
a lock body having a first channel and a second channel therein;
a plugging device being pluggable into said first channel;
a controlling device being slidably secured within said second channel;
a securing mechanism for securing or releasing said plugging device;
a restriction device slidably deposed within said second channel against said controlling device for controlling movement thereof;
a first locking means formed in said lock body for being engaged with or disengaged from said restriction device; and
a second locking means formed in said lock body for rotating said restriction device to be disengaged from said first locking means;
wherein when the restriction device is disengaged from the first locking means, said controlling device can be moved to drive the securing mechanism to release said plugging device and when the restriction device is secured by the first locking means, said second locking means can be driven by a key to have said restriction device rotated to be disengaged from said first locking means.

2. The security lock of claim 1 wherein said restriction device has a cylinder surface, and a bottom surface having a cave therein, said cylinder surface having a gap therein, said gap having a narrow section and a wide section, said first locking means comprising a combination locking means with plural number wheels and a moving element, said moving element is movable when said plural number wheels are dialed to unlocking numbers, said second locking means being a key operated locking means having a body and a rotor extended therefrom and engaged with said cave of said bottom surface for rotating said restriction device to be engaged with or disengaged from said moving element of said first locking means wherein when said moving element is within said narrow section of the gap, the restriction device is engaged with said moving element and when said moving element is within said wide section of the gap, the restriction device is disengaged from said moving element.

3. The security lock of claim 2 further comprising a compression spring deposed on top of said body of said key operated locking means and against said bottom surface of said restriction device.

4. The security lock of claim 3 further comprising a cable connected to said plugging device with one end and connected to said controlling device with the other end.

5. The security lock of claim 4 wherein said securing mechanism has a securing element for securing or releasing said plugging device and a driving element engaged with said securing element for driving the same with a first end and engaged with said controlling device with a second end, said plugging device having a neck portion for being engaged with said securing element.

6. The security lock of claim 5, further comprising an ejecting mechanism installed in said first channel for ejecting said plugging device when said securing element is disengaged from said neck portion of said plugging device.

7. The security lock of claim 1 wherein said restriction device has a top surface having a cave therein, said first locking means comprising a combination locking means having a moving element and plural number wheels for controlling said moving element to be engaged with or disengaged from said restriction device, said moving element is disengaged from said restriction device when said plural number wheels are dialed to unlocking numbers, said second locking means being a key operated locking means having a body and a rotor extended therefrom, said rotor being engaged with said cave of said top surface for rotating said restriction device to be disengaged from first locking means whereby said restriction device is movable and said controlling device can drive said securing mechanism to secure or release said plugging device.

8. The security lock of claim 7 wherein said securing mechanism is connected to said controlling device.

9. The security lock of claim 8 further comprising a compression spring deposed within said cave of said top surface and being against an inner wall thereof with one end and against said rotor of said key operated locking means with the other end.

10. The security lock of claim 9 wherein said securing mechanism has a securing element connected to said controlling device for securing or releasing said plugging device, said plugging device having a hook portion for being engaged with said securing element.
